(19) United States
(12) Patent Application Publication
(10) Pub. No.: US 2010/0138776 A1
(43) Pub. Date: Jun. 3, 2010

(54) FLICK-SCROLLING

(75) Inventor: Panu Korhonen, Helsinki (FI)

Correspondence Address: Perman & Green, LLP, 99 Hawley Lane, Stratford, CT, 06614, US

(73) Assignee: NOKIA CORPORATION, Espoo (FI)

(21) Appl. No.: 12/325,207

(22) Filed: Nov. 30, 2008

(51) Int. Cl. G06F 3/048

(52) U.S. Cl. 715/786

(57) ABSTRACT

An apparatus includes a display configured to show one or more displayed items of a plurality of items, wherein a number of the plurality of items extend off at least one end of the display, scrolling circuitry configured for sensing a touching down on the display on one or more of the displayed items and a dragging motion of the one or more displayed items in a direction, and a processor configured for automatically setting an initial speed for scrolling the plurality of items and configured for continuously reducing the scrolling speed proportionate to the plurality of items, so that scrolling slows and then stops upon reaching the last item.

### BACKGROUND

1. Field

The disclosed embodiments generally relate to user interfaces and, more particularly, to scrolling information presented on a display.

2. Brief Description of Related Developments

Occasionally, when viewing items on a screen of an electronic device, the number of items to be displayed include too many to show on the screen at once. This situation may be aggravated as electronic devices become smaller and more portable and tend to have relatively small displays. In some instances, the items may be viewed by scrolling, that is, by moving some items presently in the field of view out of the field of view and replacing them with other items.

EP0880091 discloses a method of scrolling that includes scrolling at an initial speed that is then automatically retarded, for example, by applying an exponential formula. This may result in having to scroll multiple times to arrive at a particular item in a long list.

It would advantageous to provide a method and apparatus for scrolling that eliminates multiple scrolling and provides other advantages.

### SUMMARY

The following summary is intended to exemplary only and non-limiting.

In one aspect, the disclosed embodiments are directed to a an apparatus having a display configured to show one or more displayed items of a plurality of items, wherein a number of the plurality of items extend off at least one end of the display, scrolling circuitry configured for sensing a touching down on the display on one or more of the displayed items and a dragging motion of the one or more displayed items in a direction, and a processor configured for automatically setting an initial speed for scrolling the plurality of items and configured for continuously reducing the scrolling speed proportionate to the plurality of items, so that scrolling slows and then stops upon reaching the last item.

In another aspect, the disclosed embodiments are directed to a method including touching down on one or more displayed items of a plurality of items, wherein a number of the plurality of items extend off at least one end of a display, dragging the one or more displayed items in a direction, automatically scrolling the plurality of items at an initial speed, and continuously reducing the scrolling speed proportionate to the plurality of items, so that scrolling slows and then stops upon reaching the last item.

In yet another aspect, the disclosed embodiments are directed to a method including touching down on one or more items shown on a display wherein a number of the items extend off at least one end of the display, dragging the one or more items in a direction, automatically scrolling the items at an accelerated rate and then at a speed proportionate to the number of items, and stopping the scrolling upon reaching the last item.

In still another aspect, the disclosed embodiments are directed to a computer readable medium encoded with computer program code, which when executed causes a computer to show one or more displayed items of a plurality of items on a display, wherein a number of the plurality of items extend off at least one end of the display, sense a touching down on the display on one or more of the displayed items and a dragging motion of the one or more displayed items in a direction, and automatically set an initial speed for scrolling the plurality of items and continuously reduce the scrolling speed proportionate to the plurality of items, so that scrolling slows and then stops upon reaching the last item.

Other aspects and embodiments are also contemplated.

### BRIEF DESCRIPTION OF THE DRAWINGS

The foregoing aspects and other features of the embodiments are explained in the following description, taken in connection with the accompanying drawings, wherein:

FIG. 1 shows an exemplary device 100 for practicing the disclosed embodiments;

FIG. 2 shows another embodiment of the exemplary device of FIG. 1;

FIGS. 3 and 4 illustrate flow diagrams of processes in accordance with the disclosed embodiments;

FIGS. 5A and 5B are illustrations of examples of devices that may be used to practice aspects of the disclosed embodiments;

FIG. 6 illustrates a block diagram of an exemplary system incorporating features that may be used to practice the disclosed embodiments; and

FIG. 7 shows a block diagram illustrating the general architecture of an exemplary system in which the exemplary devices of FIGS. 5A and 5B may be used.

### DETAILED DESCRIPTION OF THE EMBODIMENT(S)

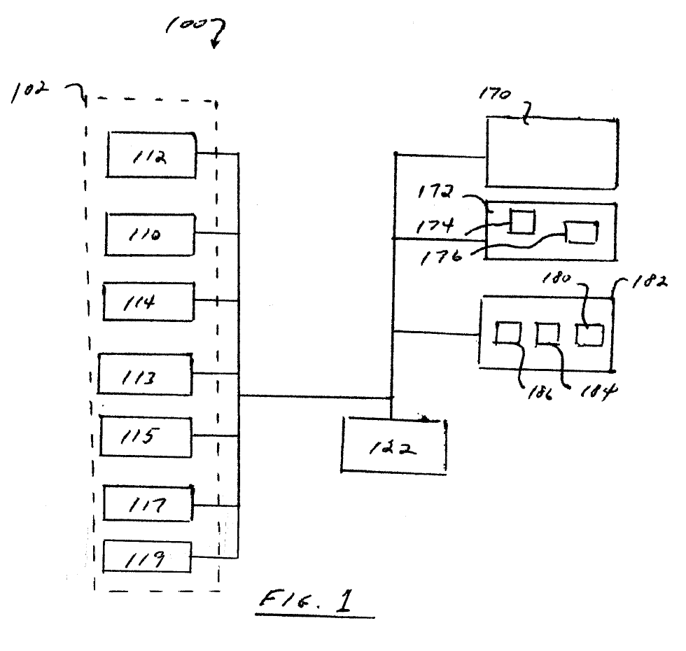

FIG. 1 illustrates one embodiment of an exemplary device 100 in which aspects of the disclosed embodiments may be applied. Although aspects of the disclosed embodiments will be described with reference to the embodiments shown in the drawings and described below, it should be understood that these aspects could be embodied in many alternate forms and in any possible combination of elements. In addition, any suitable size, shape or type of elements or materials could be used.

The disclosed embodiments may generally provide variable scrolling for items too numerous to be displayed on a screen at the same time. The scrolling speed may be continuously reduced proportional to the number of items to be scrolled. The disclosed embodiments may also provide a scrolling speed that is first accelerated at then maintained at a constant until reaching the last item or until a user stops the scrolling. Furthermore, the disclosed embodiments may provide a scrolling speed that is first accelerated and then continuously reduced, where at least one of the rate of acceleration and reduction in scrolling speed are proportional to the number of items to be scrolled.

FIG. 1 shows an exemplary device 100 for practicing the disclosed embodiments. Device 100 may be a portable device, for example, a mobile communications terminal, or may be a fixed device, for example, a terminal at a kiosk or a fixed communications terminal. Device 100 may be any suitable device, provided it includes a user interface capable of performing the operations described according to the disclosed embodiments. Device 100 may have a user interface 102, including at least one touch screen display 112 and scrolling circuitry 119. Device 100 may also include a processor 122, a storage device 182, and optionally a communications function 170 and a location function 172. The components of device 100 may be implemented in any combination of hardware and software.

The user interface 102 of the disclosed embodiments may include input and output devices for interaction with one or more users. User interface 102 may include both touch and non-touch devices. Touch devices may include a touch screen or proximity screen device 112 which may be responsive to user input and may also include a display. In alternate embodiments, the aspects of the user interface 102 disclosed herein may be embodied on any suitable device that will display information and allow the selection and activation of applications, system content, and the functions of the embodiments described herein. The terms “select” and “touch” are generally described with respect to a touch screen-display. However, in alternate embodiments, the terms are also intended to encompass required user action with respect to other input devices. For example, with respect to the touch/proximity screen device 112, it may not be necessary for a user to make direct contact with the touch/proximity screen device 112 in order to select an object, other information, or to initiate an application.

Thus, the above noted terms are intended to encompass that a user only needs to be within the proximity of touch/proximity screen device 112 to carry out the desired function. For example, the term “touch” in the context of the touch/proximity screen device 112, does not necessarily require direct contact, but may include near or close contact that activates the touch/proximity screen device 112. Similarly, the scope of the intended devices is not limited to single touch or contact devices.

Examples of single and multi-touch operations may include a touchdown, where a user touches a particular part of the a screen of the touch/proximity screen device 112, a touch release, where a user ends contact with the touch/proximity screen 112, a move, where the user touches the touch/proximity screen 112 and moves while maintaining contact with the screen, a pinch, where the user touches the touch/proximity screen device 112 in two points and “drags” the two points together or apart, and a rotation, where the user touches the touch/proximity screen device 112 in two points and rotates the points. Any operations where contact by one or more fingers or other pointing devices can navigate on and about the screen are also intended to be encompassed by the disclosed embodiments.

Scrolling circuitry 119 may include sensors associated with touch display 112 for sensing single and multi-touch operations and causing items displayed on the touch screen to move accordingly. Scrolling circuitry 119 typically communicates with processor 122 and storage device 182 including applications 180 and application settings 184, described below.

Non-touch devices 117 are also intended to be encompassed by the disclosed embodiments. Non-touch devices may include, but are not limited to, brain computer interfaces (BCI) and devices without touch or proximity screens. In one embodiment, with non-touch devices such as BCI a user may use thoughts to control the devices described herein (i.e. through neuro-physiological signals detected from the brain or from other suitable nervous tissue).

The user interface 102 may also include keys 110, for example, hard keys, soft keys, a keyboard, etc. for receiving user input, and a microphone 113 for receiving voice commands. The user interface 102 may also include a tactile response device 115, for example, a vibrator, or other device that provides tactile feedback to the user as a user performs a non-touch, touch or multi-touch operation. For example, the tactile response device 115 may be built into the display and may cause a “press back” in the area touched by the user. In other examples, the tactile response device 115 may simply vibrate or may provide any other form of tactile response that presents a user with an indication that an input has been recognized.

The user interface 102 may also include one or more displays 114 which, as mentioned above, may be part of touch/proximity screen 112, or may be separate devices. The one or more displays generally provide information to a user including menus for selecting functions of the device 100.

Still referring to FIG. 1, the processor 122 operates to control the functions of the device 100. The processor may receive inputs, for example, signals, transmissions, instructions or commands related to the functions of the device 100 from user interface 102, scrolling circuitry 119, storage device 182, and communications function 170. The processor 122 interprets the inputs and controls the functions of the device 100 accordingly. In some embodiments, the processor 122 receives inputs from the user interface 102 related to selecting icons on the display 114, navigating menu structures, or otherwise making selections and initiating applications. In response, the processor 122 displays desired items on the display 114 and runs the requested applications. In particular, the processor may receive user input related to scrolling items across the display 112 and may control the scrolling acceleration, constant speed, and deceleration as will be described below.

The processor 122, in combination with one or more of the user interface 102, scrolling circuitry 119, and programs in the storage device 182 may operate to sense when a number of items are too numerous to be displayed and when a user touches down on one or more displayed items of the number of items. The processor 122, in combination with the other components, may also determine that the user is dragging the one or more displayed items in a direction, and may operate to automatically scroll the items at an initial speed and continuously reduce the scrolling speed proportionate to the number of items, so that scrolling slows and then stops upon reaching the last item. The processor 122 and scrolling circuitry 119 may determine an initial scrolling speed related to the user's initial dragging speed, or may provide an initial pre-set scrolling speed. In some embodiments, the processor 122 and scrolling circuitry 119 may cause the scrolling to accelerated from the initial scrolling speed at an initial rate. The rate of acceleration may be proportional to the total number of items to be scrolled, the number of items extending off the end of the display, or some other suitable factor.

Storage device 182 generally includes instructions or commands for the processor 122 related to the functions of the device 100. Storage device 182 includes computer readable media encoded with computer executable components, software, programs, instructions, commands, etc. for implementing the embodiments disclosed herein, in particular, operations related to scrolling items across touch display 112. Storage device 182 may utilize optical, magnetic, chemical, electrical, or any other suitable properties for receiving, storing, or delivering instructions and commands. Storage device 182 may include magnetic media, such as a diskette, disk, memory stick or computer hard drive, which is readable and executable by a computer. In other embodiments, storage device 182 may include optical disks, read-only-memory (“ROM”) floppy disks and semiconductor materials and chips. Storage device 182 may generally utilize any suitable technology for implementing the embodiments disclosed herein.

Storage device 182 may also include applications 180 and application settings 184 for other functions, for example, data acquisition (e.g. image, video and sound), data processing (spread sheets, word processor, contact lists, currency converters, etc.), multimedia players (e.g. video and music players), various web services, and any other suitable applications. Storage device 182 may also include one or more databases 186 that include data, maps, contact information, or other information.

Communications function 170 may include circuitry and programs for providing any suitable communications tasks for implementing the disclosed embodiments. Communications function may include facilities for any type of satellite, mobile, wireless, wide area network, local area network, or public switched telephone network communications, or any other suitable communication facilities.

Location function 172 may generally include circuitry and programs for determining the location, orientation, and forces being applied to the device 100. For example, location function 172 may include a global positioning system processor 174, a compass, one or more accelerometers, and any other suitable sensors referred to collectively as sensors 176. As a further example, device 100 may use the global positioning system processor 174 to determine its own location.

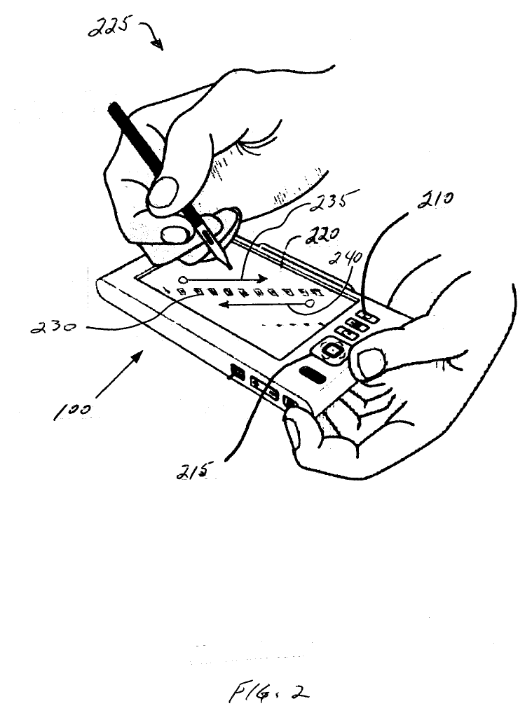

FIG. 2 shows an exemplary embodiment of device 100. Device 100 may have a keypad 200, cursor control 215, a touch screen display 220, and a pointing device 225, for example, a stylus or finger, for use on the touch screen display 220. Items 230 are displayed on the touch screen display 220, a number of which extend off at least one end of the display 220. The items may be scrolled by a flick scrolling action, for example, touching down on one or more of the items 230 and dragging the items in a particular direction. Arrows 235 and 240 show examples of this movement. While arrows 235, 240 show movement in a diagonal direction, it should be noted that the movement may occur in any direction. As the items are being dragged, they begin to scroll in the dragging direction. The items continue to scroll until the user touches down on the scrolling items or until reaching the last item.

In some embodiments, the scrolling begins at an initial speed which is continuously reduced proportionate to the number of items, so that scrolling slows and eventually stops upon reaching the last item. Thus, the overall scrolling speed may be higher for a higher number of items and lower for a lower number of items. For larger numbers of items this advantageously allows a user to find at least one of the items quickly and easily without making excessive flicking motions. The initial speed may be related to the initial dragging speed, may be a pre-set speed, or may be accelerated at an initial rate. After an initial speed or acceleration has been reached, the scrolling speed may be continuously reduced proportionate to the number of items until reaching the last item, where scrolling stops. In other embodiments, the scrolling speed is maintained at a constant speed until reaching the last item. Various combinations of initial scrolling speed, initial acceleration, continuous reduction, and constant scrolling speed are also contemplated. For example, an initial accelerated scrolling may be provided and then the scrolling speed may be continuously reduced, where at least one of the rate of acceleration and reduction in scrolling speed are proportional to the number of items to be scrolled.

In some embodiments, the scrolling speed is selected so that the scrolling items are discernable while scrolling, that is, a user is able to visually determine each item. For example, where the scrolling items are text items, a scrolling speed may be determined such that each text item may be read by a user. As another example, where the scrolling items are icons, a scrolling speed may be determined such that each icon is distinguishable by a user.

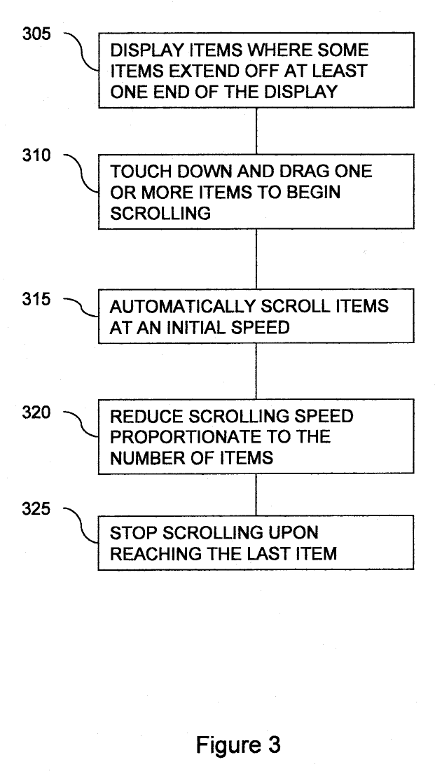

FIG. 3 illustrates a flow diagram of a process in accordance with the disclosed embodiments. In block 305, items are shown on a display, a number of which extend off at least one end of the display. In block 310, a user may initiate scrolling of the items by touching down on one or more of the items and dragging the one or more items in a particular direction. In block 315, the items are automatically scrolled at an initial speed. In block 320, the initial scrolling speed is continuously reduced proportionate to the number of items, and in block 325 the scrolling stops upon reaching the last item.

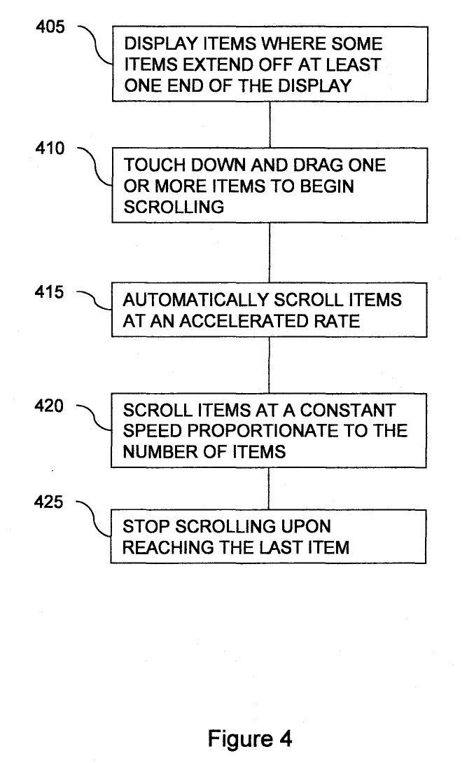

FIG. 4 illustrates a flow diagram of another process in accordance with the disclosed embodiments. In block 405, items are shown on a display, a number of which extend off at least one end of the display. In block 410, a user may initiate scrolling of the items by touching down on one or more of the items and dragging the one or more items in a particular direction. In block 415 the items are automatically scrolled at an accelerated rate, and in block 420 the items are scrolled at a constant speed proportionate to the number of items. In block 425 scrolling is halted upon reaching the last item.

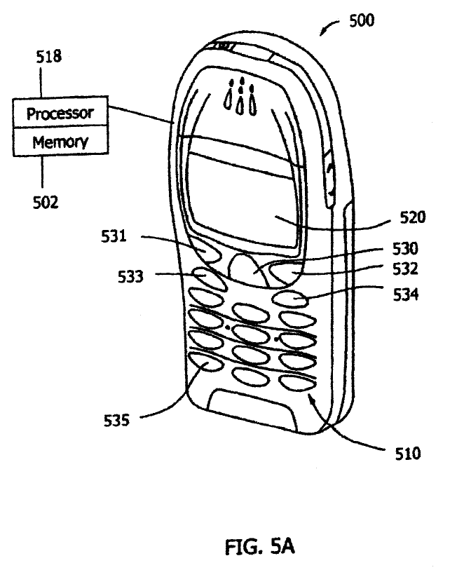

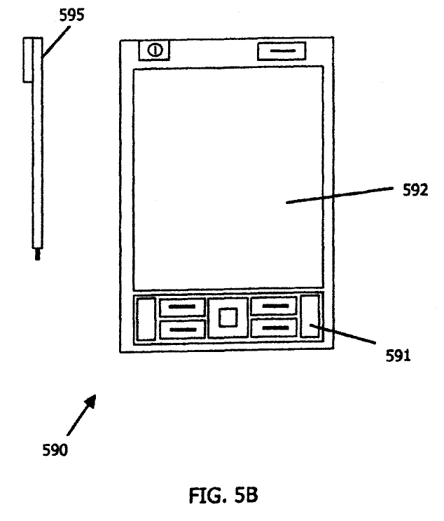

Examples of devices on which aspects of the disclosed embodiments can be practiced are illustrated with respect to FIGS. 5A and 5B. A terminal or mobile communications device 500 may incorporate all the functions of an augmented reality display device as described above. The terminal or mobile communications device 500 have a keypad 510 and a display 520. The keypad 510 may include any suitable user input devices such as, for example, a multi-function/scroll key 530, soft keys 531, 532, a call key 533, an end call key 534 and alphanumeric keys 535. The display 520 may be any suitable display, such as for example, a touch screen display or graphical user interface. The display may be integral to the device 500 or the display may be a peripheral display connected to the device 500. A pointing device, such as for example, a stylus, pen or simply the user's finger may be used with the display 520. In alternate embodiments any suitable pointing device may be used. In other alternate embodiments, the display may be for example a flat display that is typically made of an liquid crystal display (LCD) with optional back lighting, such as a thin film transistor (TFT) matrix capable of displaying color images. In still other alternate embodiments, the display may be any suitable conventional display.

The device 500 may also include other suitable features such as, for example, a camera, loud speaker, connectivity port or tactile feedback features. The mobile communications device may have a processor 518 connected to the display for processing user inputs, displaying information on the display 520, and for controlling the terminal or mobile communications device 500 according to the augmented reality display embodiments described herein. A memory 502 may be connected to the processor 518 for storing any suitable information and/or applications associated with the mobile communications device 500 such as phone book entries, calendar entries, instructions or commands related to the functions of displaying augmented reality disclosed herein, etc. Memory 502 may include computer readable media encoded with computer executable components software, programs, instructions, commands, etc. for implementing the embodiments disclosed herein.

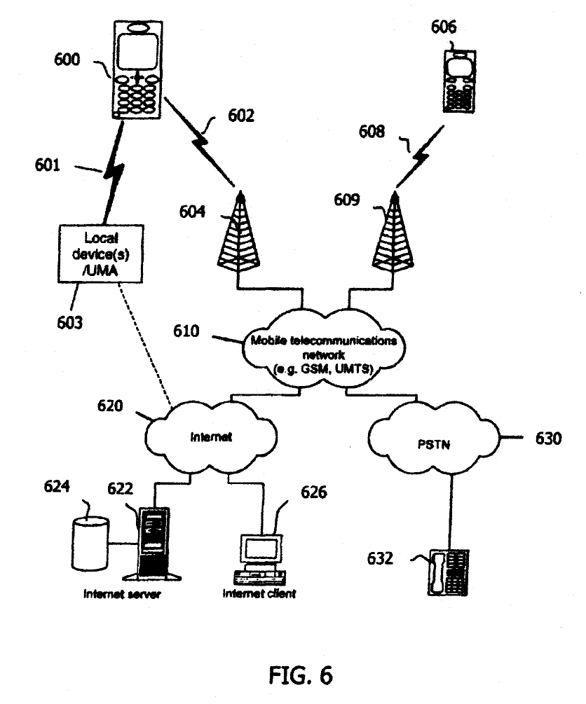

In the embodiment where the device 500 comprises a mobile communications device, the device can be adapted for communication in a telecommunication system, such as that shown in FIG. 6. In such a system, various telecommunications services such as cellular voice calls, worldwide web/wireless application protocol (www/wap) browsing, cellular video calls, data calls, facsimile transmissions, data transmissions, music transmissions, still image transmission, video transmissions, electronic message transmissions and electronic commerce may be performed between a mobile terminal 600 and other devices, such as another mobile terminal 606, a line telephone 632, a personal computer 626 and/or an internet server 622.

The mobile terminal 600 generally includes all the features of terminal or mobile communications device 500 and device 100. It is to be noted that for different embodiments of the mobile terminal 600 and in different situations, some of the telecommunications services indicated above may or may not be available. The aspects of the disclosed embodiments are not limited to any particular set of services in this respect.

The mobile terminals 600, 606 may be connected to a mobile telecommunications network 610 through radio frequency (RF) links 602, 608 via base stations 604, 609. The mobile telecommunications network 610 may be in compliance with any commercially available mobile telecommunications standard such as for example global system for mobile communications (GSM), universal mobile telecommunication system (UMTS), digital advanced mobile phone service (D-AMPS), code division multiple access 2000 (CDMA2000), wideband code division multiple access (WCDMA), wireless local area network (WLAN), freedom of mobile multimedia access (FOMA) and time division-synchronous code division multiple access (TD-SCDMA).

The mobile telecommunications network 610 may be operatively connected to a wide area network 620, which may be the Internet or a part thereof. An Internet server 622 has data storage 624 and is connected to the wide area network 620, as is an Internet client computer 626. In some embodiments, data storage 624 may include applications for implementing the functions related to scrolling items as described above.

The server 622 may host a worldwide web/wireless application protocol server capable of serving worldwide web/wireless application protocol content to the mobile terminal 600. A public switched telephone network (PSTN) 630 may be connected to the mobile telecommunications network 610 in a familiar manner. Various telephone terminals, including the stationary telephone 632, may be connected to the public switched telephone network 630.

The mobile terminal 600 is also capable of communicating locally via a local link 601 to one or more local devices 603. The local link 601 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The above examples are not intended to be limiting, and any suitable type of link may be utilized. The local devices 603 may be antennas and supporting equipment forming a wireless local area network implementing Worldwide Interoperability for Microwave Access (WiMAX, IEEE 802.16), WiFi (IEEE 802.11x) or other communication protocols. The wireless local area network may be connected to the Internet. The mobile terminal 600 may thus have multi-radio capability for connecting wirelessly using mobile communications network 610, wireless local area network or both. Communication with the mobile telecommunications network 610 may also be implemented using WiFi, Worldwide Interoperability for Microwave Access, or any other suitable protocols, and such communication may utilize unlicensed portions of the radio spectrum (e.g. unlicensed mobile access (UMA)). In one embodiment, the processor 122 of FIG. 1 and the communications function 170 may be configured to interact with the system described with respect to FIG. 6.

Although the above embodiments are described as being implemented on and with a mobile communication device, it will be understood that the disclosed embodiments can be practiced on any suitable device incorporating a display, processor, memory and supporting software or hardware. In one embodiment, the device 100 of FIG. 1 may be implemented in, for example, a personal digital assistant (PDA) style device 590 illustrated in FIG. 5B. The personal digital assistant 590 may have a keypad 591, a touch screen display 592 and a pointing device 595 for use on the touch screen display 592. In still other alternate embodiments, the device may be a personal computer, a tablet computer, touch pad device, Internet tablet, a laptop or desktop computer, a mobile terminal, a cellular/mobile phone, a multimedia device, a personal communicator, or any other suitable device capable of containing, for example, a display 114 shown in FIG. 1, and supported electronics such as the processor 122 and memory 182.

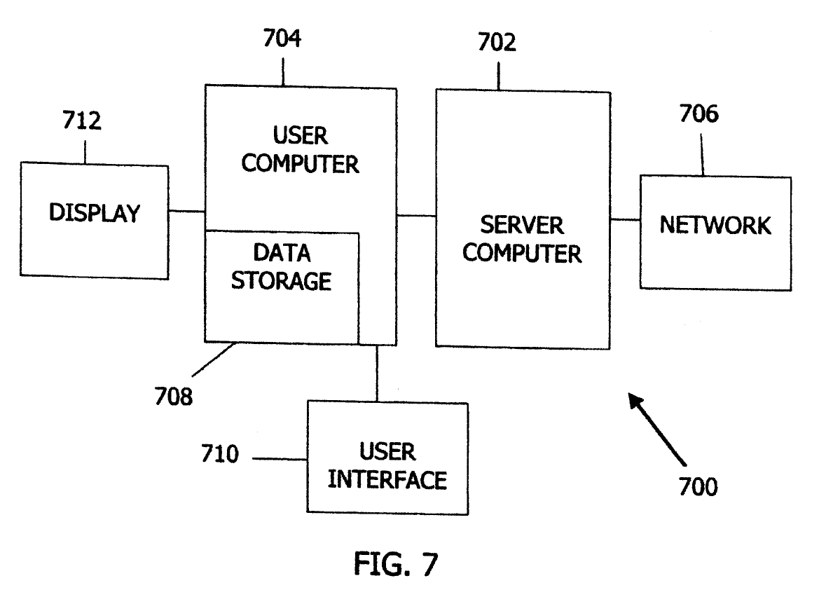

The disclosed embodiments may also include software and computer programs incorporating the process steps and instructions described above that are executed in different computers. FIG. 7 is a block diagram of one embodiment of a typical apparatus 700 incorporating features that may be used to practice aspects of the disclosed embodiments. The apparatus 700 can include a computer readable media with computer executable components or program code embodied therein for implementing the disclosed embodiments. As shown, a computer system 702 may be linked to another computer system 704, such that the computers 702 and 704 are capable of sending information to each other and receiving information from each other. Computer 704 generally includes all the features of device 100.

In one embodiment, computer system 702 could include a server computer adapted to communicate with a network 706. Computer systems 702 and 704 can be linked together in any conventional manner including, for example, a modem, wireless, hard wire connection, or fiber optic link. Generally, information can be made available to both computer systems 702 and 704 using a communication protocol typically sent over a communication channel or through a dial-up connection on an integrated services digital network (ISDN) line. Computers 702 and 704 are generally adapted to utilize program storage devices with computer readable media embodying computer executable components, for example, machine-readable program source code, which is adapted to cause the computers 702 and 704 to implement the embodiments disclosed herein. The program storage devices incorporating aspects of the disclosed embodiments may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 702 and 704 may also include a microprocessor for executing stored programs. Computer 704 may include a data storage device 708 on its program storage device for the storage of information and data. The computer program or software implementing the disclosed embodiments may be stored in one or more computers 702 and 704 on an otherwise conventional program storage device. In one embodiment, computers 702 and 704 may include a user interface 710, and a display interface 712 from which aspects of the disclosed embodiments may be accessed. The user interface 710 and the display interface 712 may be adapted to allow the input of queries and commands to the system, as well as present the results of the commands and queries.

The exemplary embodiments described herein are provided as non-limiting examples of scrolling techniques that include automatically scrolling the items at an initial speed which is gradually reduced proportionate to the number of items, so that scrolling slows and eventually stops upon reaching the last item, and also automatically scrolling the items at an accelerated rate and then at a speed proportionate to the number of items and stopping the scrolling upon reaching the last item.

It is noted that the embodiments described herein may be used individually or in any combination thereof. It should be understood that the foregoing description is only illustrative of the embodiments. Various alternatives and modifications may be devised by those skilled in the art without departing from the embodiments. Accordingly, the present embodiments are intended to embrace all such alternatives, modifications and variances that fall within the scope of the disclosure.

What is claimed is:

1. An apparatus comprising:
a display configured to show one or more displayed items of a plurality of items, wherein a number of the plurality of items extend off at least one end of the display;
scrolling circuitry configured for sensing a touching down on the display on one or more of the displayed items and a dragging motion of the one or more displayed items in a direction; and
a processor configured for automatically setting an initial speed for scrolling the plurality of items and configured for continuously reducing the scrolling speed proportionate to the plurality of items, so that scrolling slows and then stops upon reaching the last item.

2. The apparatus of claim 1, wherein the processor is configured to determine an initial scrolling speed related to an initial dragging speed.

3. The apparatus of claim 1, wherein the processor is configured to determine an initial pre-set scrolling speed.

4. The apparatus of claim 1, wherein the processor is configured to determine an initial rate of acceleration of the scrolling speed.

5. The apparatus of claim 1, wherein the processor is configured to determine a scrolling speed that renders the scrolling items discernable while scrolling.

6. The apparatus of claim 1, wherein the processor is configured to reduce the scrolling speed proportionate to the number of items extending off at the least one end of the display.

7. A method comprising:
touching down on one or more displayed items of a plurality of items, wherein a number of the plurality of items extend off at least one end of a display;
dragging the one or more displayed items in a direction;
automatically scrolling the plurality of items at an initial speed; and
continuously reducing the scrolling speed proportionate to the plurality of items, so that scrolling slows and then stops upon reaching the last item.

8. The method of claim 7, wherein an initial scrolling speed is related to an initial dragging speed.

9. The method of claim 7, wherein an initial scrolling speed is a pre-set speed.

10. The method of claim 7, wherein the scrolling is accelerated from the initial scrolling speed at an initial rate.

11. The method of claim 7, wherein an initial scrolling speed is selected so that the scrolling items are discernable while scrolling.

12. The method of claim 7, comprising further reducing the scrolling speed proportionate to the number of items extending off at the least one end of the display.

13. A method comprising:
touching down on one or more items shown on a display wherein a number of the items extend off at least one end of the display;
dragging the one or more items in a direction;
automatically scrolling the items at an accelerated rate and then at a speed proportionate to the number of items; and
stopping the scrolling upon reaching the last item.

14. A computer readable medium encoded with computer program code, which when executed causes a computer to:
show one or more displayed items of a plurality of items on a display, wherein a number of the plurality of items extend off at least one end of the display;
sense a touching down on the display on one or more of the displayed items and a dragging motion of the one or more displayed items in a direction; and
automatically set an initial speed for scrolling the plurality of items and continuously reduce the scrolling speed proportionate to the plurality of items, so that scrolling slows and then stops upon reaching the last item.

15. The computer readable medium of claim 14, further comprising computer program code for causing the computer to determine an initial scrolling speed related to an initial dragging speed.

16. The computer readable medium of claim 14, further comprising computer program code for causing the computer to determine an initial pre-set scrolling speed.

17. The computer readable medium of claim 14, further comprising computer program code for causing the computer to determine an initial rate of acceleration of the scrolling speed.

18. The computer readable medium of claim 14, further comprising computer program code for causing the computer to determine a scrolling speed that renders the scrolling items discernable while scrolling.

19. The computer readable medium of claim 14, further comprising computer program code for causing the computer to reduce the scrolling speed proportionate to the number of items extending off at the least one end of the display.
